(19) United States
(12) Patent Application Publication
(10) Pub. No.: US 2026/0172994 A1
(43) Pub. Date: Jun. 18, 2026

(54) SYNCHRONIZATION SOURCE SELECTION METHOD AND APPARATUS

(71) Applicant: Beijing Xiaomi Mobile Software Co., Ltd., Beijing (CN)

(72) Inventor: Xing YANG, Beijing (CN)

(73) Assignee: Beijing Xiaomi Mobile Software Co., Ltd., Beijing (CN)

(21) Appl. No.: 19/126,468

(22) PCT Filed: Nov. 4, 2022
(86) PCT No.: PCT/CN2022/130126

§ 371 Date: May 1, 2025

(51) Int. Cl. H04W 56/00; H04W 84/06; H04W 92/18

(52) U.S. Cl. CPC H04W 56/001; H04W 84/06; H04W 92/18

(57) ABSTRACT

Synchronization source selection methods, communication apparatuses, and storage mediums are provided. The method includes: determining a target synchronization source for performing sidelink communication, where the target synchronization source is a second terminal device or a global navigation satellite system (GNSS), and the second terminal device is an on-network terminal device.

### CROSS-REFERENCE TO RELATED APPLICATIONS

The present disclosure is a U.S. national phase of PCT Application No. PCT/CN2022/130126 filed on Nov. 4, 2022, the content of which is hereby incorporated by reference in its entirety.

### TECHNICAL FIELD

The present disclosure relates to a field of communication technologies, and in particular, to a synchronization source selection method and apparatus.

### BACKGROUND

A sidelink communication manner is introduced to support direct communication between terminal devices. A first terminal device may communicate with a base station through a relay of a second terminal device, where the first terminal device may be referred to as a remote terminal device, and the second terminal device providing the relay function is referred to as a relay terminal device. In addition, the remote terminal device may be connected to the base station through the relay terminal device, and is directly connected to the base station.

### SUMMARY

In a first aspect, an embodiment of the present disclosure provides a synchronization source selection method. The method is performed by a first terminal device, and includes: determining a target synchronization source for performing sidelink communication, where the target synchronization source is a second terminal device or a global navigation satellite system (GNSS), and the second terminal device is an on-network terminal device.

In a second aspect, an embodiment of the present disclosure provides another synchronization source selection method. The method is performed by a second terminal device, and includes: sending indication information to a first terminal device, where the indication information indicates that the second terminal device is within a network coverage range, and the indication information is configured for the first terminal device to determine that the second terminal device is an on-network terminal device.

In a third aspect, an embodiment of the present disclosure provides still another synchronization source selection method. The method is performed by a base station, and includes: sending, to a first terminal device, information indicating that a synchronization source is the base station or information indicating that a synchronization source of a specific frequency is the base station; where the information indicating that the synchronization source is the base station or the information indicating that the synchronization source of the specific frequency is the base station is configured for the first terminal device to determine a target synchronization source for performing sidelink communication, the target synchronization source is a second terminal device or a global navigation satellite system (GNSS), and the second terminal device is an on-network terminal device.

In a fourth aspect, an embodiment of the present disclosure provides a communication apparatus. The communication apparatus includes a processor and a memory, the memory stores a computer program, and the processor executes the computer program stored in the memory, to cause the communication apparatus to perform the method in the first, second, or third aspect.

In a fifth aspect, an embodiment of the present disclosure provides a communication apparatus. The apparatus includes a processor and an interface circuit. The interface circuit is configured to receive code instructions and transmitting the code instructions to the processor, and the processor is configured to execute the code instructions to cause the apparatus to perform the method in the first, second, or third aspect.

### BRIEF DESCRIPTION OF DRAWINGS

In order to more clearly illustrate technical solutions in the embodiments of the present disclosure or in the background, the accompanying drawings that need to be used in the embodiments of the present disclosure or the background will be described below.

FIG. 1 is an architectural diagram of a communication system provided by an embodiment of the present disclosure.

FIG. 2 is a flowchart of a synchronization source selection method provided by an embodiment of the present disclosure.

FIG. 3 is a flowchart of another synchronization source selection method provided by an embodiment of the present disclosure.

FIG. 4 is a flowchart of still another synchronization source selection method provided by an embodiment of the present disclosure.

FIG. 5 is a flowchart of still another synchronization source selection method provided by an embodiment of the present disclosure.

FIG. 6 is a flowchart of still another synchronization source selection method provided by an embodiment of the present disclosure.

FIG. 7 is a flowchart of still another synchronization source selection method provided by an embodiment of the present disclosure.

FIG. 8 is a flowchart of still another synchronization source selection method provided by an embodiment of the present disclosure.

FIG. 9 is a flowchart of still another synchronization source selection method provided by an embodiment of the present disclosure.

FIG. 10 is a flowchart of still another synchronization source selection method provided by an embodiment of the present disclosure.

FIG. 11 is a flowchart of still another synchronization source selection method provided by an embodiment of the present disclosure.

FIG. 12 is a flowchart of still another synchronization source selection method provided by an embodiment of the present disclosure.

FIG. 13 is a flowchart of still another synchronization source selection method provided by an embodiment of the present disclosure.

FIG. 14 is a structural diagram of a communication apparatus provided by an embodiment of the present disclosure.

FIG. 15 is a structural diagram of another communication apparatus provided by an embodiment of the present disclosure.

FIG. 16 is a schematic structural diagram of a chip provided by an embodiment of the present disclosure.

### DETAILED DESCRIPTION

For ease of understanding, a term involved in the present disclosure is first described.

### 1. Cell (Mobile Communication Term)

The cell, which may also be referred to as a cellular cell, refers to an area covered by a base station or a part of a base station (a sector antenna) in a cellular mobile communication system. In the area, a mobile station may reliably communicate with the base station through a wireless channel. There may be one or more wave beams in one cell.

In order to better understand the synchronization source selection method disclosed in the embodiments of the present disclosure, a communication system applicable to the embodiments of the present disclosure is described firstly below.

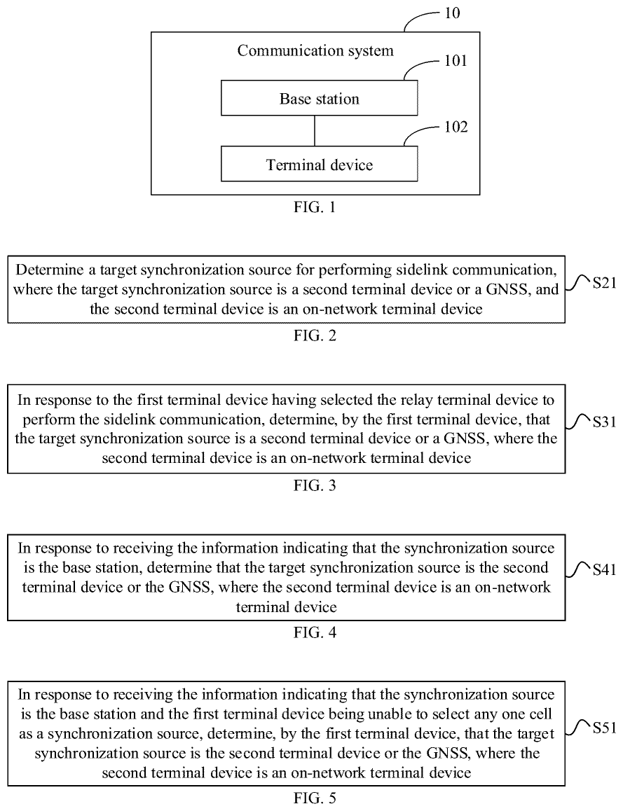

Referring to FIG. 1, FIG. 1 is a schematic architectural diagram of a communication system provided by an embodiment of the present disclosure. The communication system may include, but is not limited to, one base station and one terminal device. The number of devices and forms of the devices shown in FIG. 1 are only exemplary and do not constitute limitations to the embodiments of the present disclosure. In a practical application, the communication system may include two or more base stations and two or more terminal devices. The communication system 10 shown in FIG. 1 may include one base station 110 and one terminal device 102 as an example.

It should be noted that technical solutions of the embodiments of the present disclosure may be applied to various types of communication systems, for example, a long term evolution (LTE) system, a 5th generation (5G) mobile communication system, a 5G new radio (NR) system, or other future new mobile communication systems, etc.

The base station 101 in the embodiments of the present disclosure is an entity for sending or receiving a signal on a network side. For example, the base station 101 may be an evolved NodeB (eNB), a transmission reception point (TRP), a next generation NodeB (gNB) in an NR system, a base station in other future mobile communication systems, or an access node in a wireless fidelity (WiFi) system, etc. Specific technologies and specific device forms adopted by the base station are not limited in the embodiments of the present disclosure. The base station provided in the embodiments of the present disclosure may be composed of a central unit (CU) and a distributed unit (DU). The CU may also be referred to as a control unit. A protocol layer of the base station may be split by using a structure of a CU-DU. Functions of a part of the protocol layer are centrally controlled by the CU, and functions of the remaining part or all of the protocol layer are distributed in the DU, such that the CU centrally controls the DU.

The terminal device 102 in the embodiments of the present disclosure is an entity for receiving or sending a signal on a user side, for example a mobile phone. The terminal device 102 may also be referred to as user equipment (UE), a mobile station (MS), a mobile terminal (MT), etc. The terminal device may be a car with a communication function, a smart car, a mobile phone, a wearable device, a Pad, a computer with a wireless transceiving function, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, a wireless terminal device in a smart home, etc. Specific technologies and specific device forms adopted by the terminal device are not limited in the embodiments of the present disclosure.

It may be understood that the communication system described in the embodiments of the present disclosure is used to describe the technical solutions in the embodiments of the present disclosure more clearly, and does not constitute a limitation on the technical solutions provided in the embodiments of the present disclosure. Those skilled in the art may know that with evolution of system architectures and emergence of new business scenarios, the technical solutions provided in the embodiments of the present disclosure are also applicable to similar technical problems.

In addition, for ease of understanding the embodiments of the present disclosure, the following descriptions are made.

First, in the embodiments of the present disclosure, “used for indicating” may include “used for directly indicating” and “used for indirectly indicating”. When describing that certain information is used for indicating A, it may include that the information directly indicates A or indirectly indicates A, and does not mean that the information must carry A.

The information indicated by the information is referred to as to-be-indicated information, and in a specific implementation process, there are many manners for indicating the to-be-indicated information, for example, but not limited to, directly indicating the to-be-indicated information, for example, the to-be-indicated information itself or an index of the to-be-indicated information, etc. The to-be-indicated information may also be indirectly indicated by indicating other information, where there is an association relationship between the other information and the to-be-indicated information. Alternatively, only a part of the to-be-indicated information may be indicated, and the remaining parts of the to-be-indicated information are known or pre-agreed. For example, the specific information may also be indicated by means of a pre-agreed (for example, specified in a protocol) arrangement order of respective information, thereby reducing indication overheads to some extent.

The to-be-indicated information may be sent together as a whole, or may be divided into a plurality of pieces of sub-information and be sent separately, and sending periods and/or sending occasions of the plurality of pieces of sub-information may be the same or different. The specific sending method is not limited in the present disclosure. The sending periods and/or sending occasions of the plurality of pieces of sub-information may be predefined, for example, predefined according to a protocol.

Second, “first”, “second”, and various numerical numbers (for example, “#1” and “#2”) in the present disclosure are only for distinguishing for the convenience of description, are not intended to limit the scope of the embodiments of the present disclosure, and for distinguishing for example different terminal devices, etc.

Third, the “protocol” involved in the embodiments of the present disclosure may refer to a standard protocol in the communication field, and may include for example an LTE protocol, an NR protocol, a WLAN protocol, and related protocols in other communication systems, which is not limited in the present disclosure.

Fourth, the embodiments of the present disclosure list multiple implementations to clearly describe technical solutions of the embodiment of the present disclosure. Of course, those skilled in the art may understand that the multiple embodiments provided by the embodiments of the present disclosure may be executed separately, or may be executed together with methods of other embodiments in embodiments of the present disclosure, or may be executed separately or together with some methods in other related technologies, which is not limited in the embodiments of the present disclosure.

A sidelink communication manner is introduced to support direct communication between terminal devices, and an interface between the terminal devices is a PC-5. Three transmission modes, unicast, multicast, and broadcast, are supported on the sidelink according to the correspondence relationship between a sending terminal device and a receiving terminal device. The sending terminal device sends sidelink control information (SCI) on a physical sidelink control channel (PSCCH) and sends second stage SCI on a physical sidelink shared channel (PSSCH), which carries a resource location for transmitting data, a source identifier, a target identifier, and the like. After the receiving terminal device receives the SCI, the receiving terminal device determines, according to the identifier of the source terminal device and the identifier of the destination terminal device in the SCI, whether to receive corresponding data and which process corresponds to it. In a unicast connection, each terminal device corresponds to one destination identifier. In the multicast, each terminal device may belong to one or more groups, and each group corresponds to one destination identifier. In the broadcast, all terminal devices correspond to at least one destination identifier.

One terminal device may be not directly connected to the base station, but communicate with the base station through a relay of another terminal device. The terminal device not connected to the base station is referred to as a remote terminal device (remote UE), the terminal device providing the relay function is referred to as a relay terminal device (relay UE), and the remote terminal device communicates with the relay terminal device through sidelink unicast. This architecture is referred to as a U2N (UE to NW (network)) relay. Even if the remote terminal device is unable to receive the signal from the base station, the remote terminal device may maintain communication with the network through the relay terminal device, so that coverage of the network may be expanded.

The remote terminal device in an idle state may send a system information request message to the relay terminal device, where the system information request message carries an identifier of requested system information. The system information request message is a sidelink RRC message (RemoteUEInformationSidelink). After receiving the request, the relay terminal device obtains corresponding system information, and the relay terminal device sends the system information to the remote terminal device with a sidelink RRC message (UuMessageTransferSidelink).

The remote terminal device in a connected state may send a system information request message to the base station, where the system information request message is an RRC message (DedicatedSIBRequest), and after the base station receives the message, the base station sends the requested system information to the remote terminal device with an RRC reconfiguration message through the relay terminal device.

In related technologies, a synchronization state needs to be maintained between terminal devices to perform sidelink communication. The terminal device may determine, based on an indication sent by the base station, that a synchronization source is the base station, and in this case, the terminal device needs to maintain synchronization with a cell. However, if the terminal device is unable to obtain the signal from the cell, the terminal device will not be able to maintain the synchronization with the cell, which will result in the failure of the sidelink communication.

A sidelink communication manner is introduced to support direct communication between terminal devices. A first terminal device may communicate with a base station through a relay of a second terminal device, where the first terminal device may be referred to as a remote terminal device, and the second terminal device providing the relay function is referred to as a relay terminal device. In addition, the remote terminal device may be connected to the base station through the relay terminal device, and is directly connected to the base station.

In related technologies, a synchronization state needs to be maintained between terminal devices to perform sidelink communication. The terminal device may determine, based on an indication sent by the base station, that a synchronization source is the base station, and in this case, the terminal device needs to maintain synchronization with a cell. However, if the terminal device is unable to obtain the signal from the cell, the terminal device will not be able to maintain the synchronization with the cell, which will result in the failure of the sidelink communication. This is an urgent problem to be solved.

Based on this, an embodiment of the present disclosure provides a synchronization source selection method. When a first terminal device determines to perform sidelink communication, the first terminal device may determine that a target synchronization source is a second terminal device or a global navigation satellite system (GNSS), where the second terminal device is an on-network terminal device. Therefore, the first terminal device may determine that the synchronization source is the second terminal device or the GNSS, and maintain synchronization with the second terminal device or the GNSS, which can avoid a failure of the sidelink communication.

The synchronization source selection method and apparatus provided by the present disclosure will be described in detail below with reference to the accompanying drawings.

Referring to FIG. 2, FIG. 2 is a flowchart of a synchronization source selection method provided by an embodiment of the present disclosure.

As shown in FIG. 2, the method is performed by a first terminal device, and the method may include but is not limited to the following step S21.

At step S21, a target synchronization source for performing sidelink communication is determined, where the target synchronization source is a second terminal device or a global navigation satellite system (GNSS), and the second terminal device is an on-network terminal device.

In the embodiment of the present disclosure, the first terminal device may be connected to the second terminal device through the sidelink communication.

In the embodiment of the present disclosure, the first terminal device determines that the target synchronization source is a second terminal device or a GNSS, where the second terminal device is an on-network terminal device. Therefore, the first terminal device may maintain the synchronization with the second terminal device or the GNSS that is the on-network terminal device during the sidelink communication, which can avoid the failure of the sidelink communication. It may be understood that the on-network terminal device is a device that can communicate with the base station, for example, the on-network terminal device is located within a network coverage range of the base station. In some implementations, the on-network terminal device is a device that can establish a connection with the base station, or a device that has established a connection with the base station. The second terminal device is an on-network terminal device.

In the embodiment of the present disclosure, the first terminal device may receive indication information sent by the second terminal device, where the indication information indicates that the second terminal device is an on-network terminal device.

The indication information may be a sidelink master information block (MasterInformationBlockSidelink) message.

The sidelink master information block may carry an on-network indication. If the on-network indication is a “first value”, it indicates that the second terminal device is an on-network terminal device; and on the contrary, it indicates that the second terminal device is not the on-network terminal device.

It should be noted that, in a scenario of the sidelink communication, the first terminal device may receive information for the base station indicating the synchronization source, or may not receive the information for the base station indicating the synchronization source. In the embodiment of the present disclosure, the first terminal device may directly determine a target synchronization source regardless of whether the base station indicates the synchronization source.

In some embodiments, the first terminal device determines that the target synchronization source is the second terminal device or the GNSS in response to the first terminal device determining to perform sidelink communication and meeting at least one of the following conditions: the first terminal device having selected a relay terminal device; receiving information indicating that a synchronization source is a base station; the first terminal device being unable to select any one cell as a synchronization source; receiving information indicating that a synchronization source of a specific frequency is a base station; or the first terminal device being unable to select any one cell of a specific frequency as a synchronization source.

In the embodiment of the present disclosure, in response to having selected the relay terminal device, the first terminal device determines that the target synchronization source is the second terminal device or the GNSS.

In the embodiment of the present disclosure, in response to receiving the information indicating that the synchronization source is the base station, the first terminal device determines that the target synchronization source is the second terminal device or the GNSS.

In the embodiment of the present disclosure, in response to the first terminal device being unable to select any one cell as the synchronization source, the first terminal device determines that the target synchronization source is the second terminal device or the GNSS.

In the embodiment of the present disclosure, in response to receiving the information indicating that the synchronization source is the base station and the first terminal device being unable to select any one corresponding cell as a synchronization source, the first terminal device determines that the target synchronization source is the second terminal device or the GNSS.

In the embodiment of the present disclosure, in response to receiving the information indicating that the synchronization source of the specific frequency is the base station, it is determined that the target synchronization source is the second terminal device or the GNSS.

In the embodiment of the present disclosure, in response to the first terminal device being unable to select a corresponding cell of a specific frequency as the synchronization source, the first terminal device determines that the target synchronization source is the second terminal device or the GNSS.

In the embodiment of the present disclosure, in response to receiving the information indicating that the synchronization source of the specific frequency is the base station and the first terminal device being unable to select any one cell of the specific frequency as a synchronization source, the first terminal device determines that the target synchronization source is the second terminal device or the GNSS.

In the embodiment of the present disclosure, in response to the first terminal device having selected a relay terminal device as the synchronization source, receiving the information indicating that the synchronization source of the specific frequency is the base station, and the first terminal device being unable to select any one cell of the specific frequency as the synchronization source, the first terminal device determines that the target synchronization source is the second terminal device or the GNSS.

It should be noted that the embodiments are not exhaustive, and are merely examples of some embodiments, and the embodiments may be implemented separately, or may be implemented through combination of multiple embodiments. The embodiments are only for illustration and do not serve as specific limitations on the scope of protection of the disclosed embodiments.

It may be understood that in the embodiment of the present disclosure, in the scenario of the sidelink communication and in the case where the first terminal device has selected the relay terminal device, it is determined that the target synchronization source is the second terminal device or the GNSS. The second terminal device may be a relay terminal device.

It may be understood that in the case where the first terminal device determines to perform the sidelink communication and receives the information indicating that the synchronization source is the base station, the first terminal device determines that the target synchronization source is the second terminal device or the GNSS.

The first terminal device determines to perform the sidelink communication, and the first terminal device may be the remote terminal device or the relay terminal device. In the case where the first terminal device is the relay terminal device, the first terminal device may directly obtain information indicating that the synchronization source is the base station from the base station. In the case where the first terminal device is the remote terminal device, the first terminal device in the connected state may directly obtain the information indicating that the synchronization source is the base station from the base station, or the first terminal device in the non-connected state may obtain the information indicating that the synchronization source is the base station from the relay terminal device.

In some embodiments, the first terminal device receives a system information block12 (SIB12) or an RRC reconfiguration message sent by the base station, where the SIB12 or the RRC reconfiguration message indicates that the synchronization source is the base station.

In the embodiment of the present disclosure, the first terminal device receives the SIB12 sent by the base station, and determines, according to the SIB12, that the information indicating that the synchronization source is the base station is received.

In the embodiment of the present disclosure, the first terminal device receives the RRC reconfiguration message sent by the base station, and determines, according to the RRC reconfiguration message, that the information indicating that the synchronization source is the base station is received.

It may be understood that in response to the first terminal device being unable to select any one cell as the synchronization source, the first terminal device determines that the target synchronization source is the second terminal device or the GNSS.

The first terminal device may determine, based on the indication from the base station, that the synchronization source is the base station, and select a corresponding cell as the synchronization source.

In the embodiment of the present disclosure, in response to receiving the information indicating that the synchronization source is the base station and the first terminal device being unable to select any one corresponding cell as a synchronization source, the first terminal device determines that the target synchronization source is the second terminal device or the GNSS.

Based on this, when the first terminal device performs the sidelink communication, the first terminal device needs to select a cell as a synchronization source; and if the first terminal device is unable to select any one cell as the synchronization source, the first terminal device may determine that the target synchronization source is the second terminal device or the GNSS.

In some embodiments, for example, if the first terminal device is unable to detect a signal from any one cell, the first terminal device determines to be unable to select any one cell as the synchronization source.

In the embodiment of the present disclosure, in the case where the first terminal device is unable to detect a signal from any one cell, the first terminal device determines that the first terminal device is unable to select any one cell as the synchronization source. The cell may be a cell providing the SIB12 or RRC reconfiguration message, or may be a cell in a sidelink communication frequency, or may be any one cell.

It may be understood that in the case where the first terminal device determines to perform the sidelink communication and receives the information indicating that the synchronization source of a specific frequency is the base station, the first terminal device determines that the target synchronization source is the second terminal device or the GNSS.

In some embodiments, the first terminal device receives the SIB12 or the RRC reconfiguration message sent by the base station, where the SIB12 or the RRC reconfiguration message indicates that the synchronization source of the specific frequency is the base station; and the first terminal device determines, according to the SIB12 or the RRC reconfiguration message, that the information indicating that the synchronization source of the specific frequency is the base station is received.

In the embodiment of the present disclosure, the first terminal device receives the SIB12 sent by the base station, and determines, according to the SIB12, that the information indicating that the synchronization source of the specific frequency is the base station is received.

In the embodiment of the present disclosure, the first terminal device receives the RRC reconfiguration message sent by the base station, and determines, according to the RRC reconfiguration message, that the information indicating that the synchronization source of the specific frequency is the base station is received.

In some embodiments, in response to synchronization between the first terminal device and the second terminal device, the first terminal device determines to maintain the synchronization with a cell. The synchronization of the first terminal device with the second terminal device may include that the first terminal device selects the target synchronization source as the second terminal device, to implement the synchronization with the second terminal device.

In the embodiments of the present disclosure, the first terminal device determines to maintain the synchronization with the cell in the case where the first terminal device is synchronized with the second terminal device, where the cell may be a cell from which the first terminal device can receive a signal, or may be a serving cell for the second terminal device.

By implementing the embodiment of the present disclosure, a first terminal device determines a target synchronization source for performing sidelink communication, where the target synchronization source is a second terminal device or a GNSS, and the second terminal device is an on-network terminal device. Therefore, the first terminal device may maintain the synchronization with the second terminal device or the GNSS that is the on-network terminal device during the sidelink communication, which can avoid the failure of the sidelink communication.

Referring to FIG. 3, FIG. 3 is a flowchart of another synchronization source selection method provided by an embodiment of the present disclosure.

As shown in FIG. 3, the method is performed by a first terminal device, and the method may include but is not limited to the following step S31.

At step S31, in response to the first terminal device having selected the relay terminal device to perform the sidelink communication, the first terminal device determines that the target synchronization source is a second terminal device or a GNSS, where the second terminal device is an on-network terminal device.

In the embodiment of the present disclosure, in the case where the first terminal device has selected the relay terminal device to perform the sidelink communication, the first terminal device determines that the target synchronization source is a second terminal device or a GNSS, where the second terminal device may be a relay terminal device.

The method of the first terminal device determining that the second terminal device is an on-network terminal device may refer to related descriptions in the embodiments, and will be not repeated herein again.

By implementing the embodiment of the present disclosure, in response to the first terminal device determining to perform the sidelink communication and the first terminal device having selected the relay terminal device, the first terminal device determines that the target synchronization source is the second terminal device or the GNSS, where the second terminal device is an on-network terminal device. Therefore, the first terminal device may maintain the synchronization with the second terminal device or the GNSS that is the on-network terminal device during the sidelink communication, which can avoid the failure of the sidelink communication.

Referring to FIG. 4, FIG. 4 is a flowchart of still another synchronization source selection method provided by an embodiment of the present disclosure.

As shown in FIG. 4, the method is performed by a first terminal device, and the method may include but is not limited to the following step S41.

At step S41, in response to receiving the information indicating that the synchronization source is the base station, it is determined that the target synchronization source is the second terminal device or the GNSS, where the second terminal device is an on-network terminal device.

The method of the first terminal device determining that the second terminal device is an on-network terminal device may refer to related descriptions in the embodiments, and will be not repeated herein again.

The first terminal device determines to perform the sidelink communication, and the first terminal device may be the remote terminal device or the relay terminal device. In the case where the first terminal device is the relay terminal device, the first terminal device may directly obtain information indicating that the synchronization source is the base station from the base station. In the case where the first terminal device is the remote terminal device, the first terminal device in the connected state may directly obtain the information indicating that the synchronization source is the base station from the base station, or the first terminal device in the non-connected state may receive the information indicating that the synchronization source is the base station from the relay terminal device.

In some embodiments, the first terminal device receives the SIB12 or the RRC reconfiguration message sent by the base station, where the SIB12 or the RRC reconfiguration message indicates that the synchronization source is the base station; and the first terminal device determines, according to the SIB12 or the RRC reconfiguration message, that the information indicating that the synchronization source is the base station is received.

In the embodiment of the present disclosure, the first terminal device receives the SIB12 sent by the base station, and determines, according to the SIB12, that the information indicating that the synchronization source is the base station is received.

In the embodiment of the present disclosure, the first terminal device receives the RRC reconfiguration message sent by the base station, and determines, according to the RRC reconfiguration message, that the information indicating that the synchronization source is the base station is received.

By implementing the embodiment of the present disclosure, in response to the first terminal device determining to perform the sidelink communication, and receiving the information indicating that the synchronization source is the base station, but the first terminal device being unable to select a corresponding cell as the synchronization source, the first terminal device determines that the target synchronization source is the second terminal device or the GNSS, where the second terminal device is an on-network terminal device. Therefore, the first terminal device may maintain the synchronization with the second terminal device or the GNSS that is the on-network terminal device during the sidelink communication, which can avoid the failure of the sidelink communication.

Referring to FIG. 5, FIG. 5 is a flowchart of still another synchronization source selection method provided by an embodiment of the present disclosure.

As shown in FIG. 5, the method is performed by a first terminal device, and the method may include but is not limited to the following step S51.

At step S51, in response to receiving the information indicating that the synchronization source is the base station and the first terminal device being unable to select any one cell as a synchronization source, the first terminal device determines that the target synchronization source is the second terminal device or the GNSS, where the second terminal device is an on-network terminal device.

The method of the first terminal device determining that the second terminal device is an on-network terminal device may refer to related descriptions in the embodiments, and will be not repeated herein again.

The first terminal device determines to perform the sidelink communication, and the first terminal device may be the remote terminal device or the relay terminal device. In the case where the first terminal device is the relay terminal device, the first terminal device may directly obtain information indicating that the synchronization source is the base station from the base station. In the case where the first terminal device is the remote terminal device, the first terminal device in the connected state may directly obtain the information indicating that the synchronization source is the base station from the base station, or the first terminal device in the non-connected state may obtain the information for the base station indicating that the synchronization source is the base station from the relay terminal device.

In some embodiments, the first terminal device receives the SIB12 or the RRC reconfiguration message sent by the base station, where the SIB12 or the RRC reconfiguration message indicates that the synchronization source is the base station; and the first terminal device determines, according to the SIB12 or the RRC reconfiguration message, that the information indicating that the synchronization source is the base station is received.

In the embodiment of the present disclosure, the first terminal device receives the SIB12 sent by the base station, and determines, according to the SIB12, that the information indicating that the synchronization source is the base station is received.

In the embodiment of the present disclosure, the first terminal device receives the RRC reconfiguration message sent by the base station, and determines, according to the RRC reconfiguration message, that the information indicating that the synchronization source is the base station is received.

The first terminal device may determine, based on the indication from the base station, that the synchronization source is the base station, and select a corresponding cell as the synchronization source.

In the embodiment of the present disclosure, when the first terminal device performs the sidelink communication, the first terminal device needs to select a cell as a synchronization source; and if the first terminal device is unable to select any one cell as the synchronization source, the first terminal device may determine that the target synchronization source is the second terminal device or the GNSS.

In some embodiments, in response to the first terminal device being unable to detect a signal from any one cell, it is determined that the first terminal device is unable to select any one cell as the synchronization source.

In the embodiment of the present disclosure, in the case where the first terminal device is unable to detect a signal from any one cell, the first terminal device determines that the first terminal device is unable to select any one cell as the synchronization source. The cell may be a cell providing the SIB12 or RRC reconfiguration message, or may be a cell in a sidelink communication frequency, or may be any one cell.

By implementing the embodiment of the present disclosure, in response to receiving the information indicating that the synchronization source is the base station and the first terminal device being unable to select any one cell as a synchronization source, the first terminal device determines that the target synchronization source is the second terminal device or the GNSS, where the second terminal device is an on-network terminal device. Therefore, the first terminal device may maintain the synchronization with the second terminal device or the GNSS that is the on-network terminal device during the sidelink communication, which can avoid the failure of the sidelink communication.

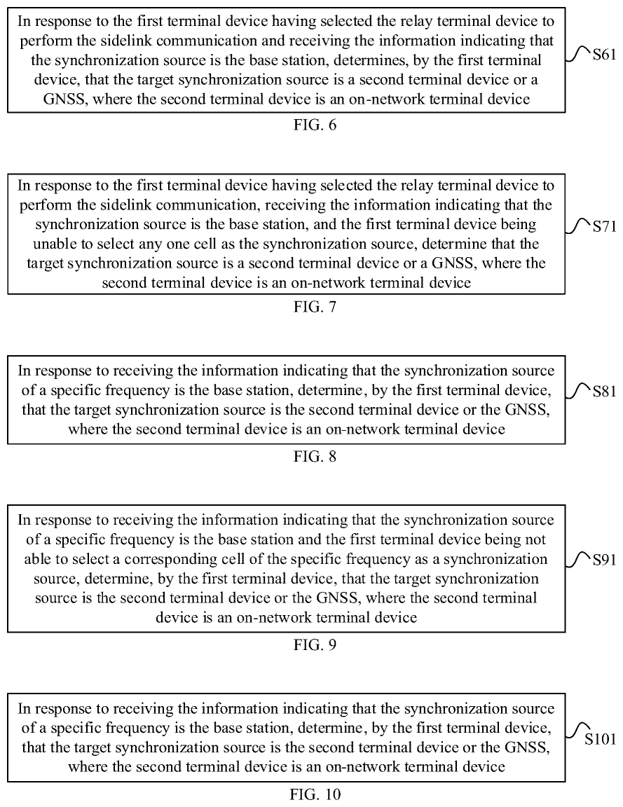

Referring to FIG. 6, FIG. 6 is a flowchart of still another synchronization source selection method provided by an embodiment of the present disclosure.

As shown in FIG. 6, the method is performed by a first terminal device, and the method may include but is not limited to the following step S61.

At step S61, in response to the first terminal device having selected the relay terminal device to perform the sidelink communication and receiving the information indicating that the synchronization source is the base station, the first terminal device determines that the target synchronization source is a second terminal device or a GNSS, where the second terminal device is an on-network terminal device.

In the embodiment of the present disclosure, in the case where the first terminal device determines to perform the sidelink communication and has selected the relay terminal device, the second terminal device may be a relay terminal device.

The method of the first terminal device determining that the second terminal device is an on-network terminal device may refer to related descriptions in the embodiments, and will be not repeated herein again.

The first terminal device determines to perform the sidelink communication, and the first terminal device has selected the relay terminal device, and the first terminal device may be the remote terminal device. In the case where the first terminal device is the remote terminal device, the first terminal device in the connected state may directly obtain the information indicating that the synchronization source is the base station from the base station, or the first terminal device in the non-connected state may obtain the information for the base station indicating that the synchronization source is the base station from the relay terminal device.

In some embodiments, the first terminal device receives the SIB12 or the RRC reconfiguration message sent by the base station, where the SIB12 or the RRC reconfiguration message indicates that the synchronization source is the base station; and the first terminal device determines, according to the SIB12 or the RRC reconfiguration message, that the information indicating that the synchronization source is the base station is received.

In the embodiment of the present disclosure, the first terminal device receives the SIB12 sent by the base station, and determines, according to the SIB12, that the information indicating that the synchronization source is the base station is received.

In the embodiment of the present disclosure, the first terminal device receives the RRC reconfiguration message sent by the base station, and determines, according to the RRC reconfiguration message, that the information indicating that the synchronization source is the base station is received.

By implementing the embodiment of the present disclosure, in response to the first terminal device having selected the relay terminal device to perform the sidelink communication and receiving the information indicating that the synchronization source is the base station, the first terminal device determines that the target synchronization source is a second terminal device or a GNSS, where the second terminal device is an on-network terminal device. Therefore, the first terminal device may maintain the synchronization with the second terminal device or the GNSS that is the on-network terminal device during the sidelink communication, which can avoid the failure of the sidelink communication.

Referring to FIG. 7, FIG. 7 is a flowchart of still another synchronization source selection method provided by an embodiment of the present disclosure.

As shown in FIG. 7, the method is performed by a first terminal device, and the method may include but is not limited to the following step S71.

At step S71, in response to the first terminal device having selected the relay terminal device to perform the sidelink communication, receiving the information indicating that the synchronization source is the base station, and the first terminal device being unable to select any one cell as the synchronization source, it is determined that the target synchronization source is a second terminal device or a GNSS, where the second terminal device is an on-network terminal device.

In the embodiment of the present disclosure, in the case where the first terminal device determines to perform the sidelink communication and has selected the relay terminal device, the second terminal device may be a relay terminal device.

The method of the first terminal device determining that the second terminal device is an on-network terminal device may refer to related descriptions in the embodiments, and will be not repeated herein again.

The first terminal device determines to perform the sidelink communication, and the first terminal device has selected the relay terminal device, and the first terminal device may be the remote terminal device. In the case where the first terminal device is the remote terminal device, the first terminal device in the connected state may directly obtain the information indicating that the synchronization source is the base station from the base station, or the first terminal device in the non-connected state may obtain the information for the base station indicating that the synchronization source is the base station from the relay terminal device.

In some embodiments, the first terminal device receives the SIB12 or the RRC reconfiguration message sent by the base station, where the SIB12 or the RRC reconfiguration message indicates that the synchronization source is the base station; and the first terminal device determines, according to the SIB12 or the RRC reconfiguration message, that the information indicating that the synchronization source is the base station is received.

In the embodiment of the present disclosure, the first terminal device receives the SIB12 sent by the base station, and determines, according to the SIB12, that the information indicating that the synchronization source is the base station is received.

In the embodiment of the present disclosure, the first terminal device receives the RRC reconfiguration message sent by the base station, and determines, according to the RRC reconfiguration message, that the information indicating that the synchronization source is the base station is received.

The first terminal device may determine, based on the indication from the base station, that the synchronization source is the base station, and select a cell as the synchronization source.

In the embodiment of the present disclosure, when the first terminal device performs the sidelink communication, the first terminal device needs to select a cell as a synchronization source; and if the first terminal device is unable to select any one cell as the synchronization source, the first terminal device may determine that the target synchronization source is the second terminal device or the GNSS.

In some embodiments, in response to the first terminal device being unable to detect a signal from any one cell, the first terminal device determines that the first terminal device is unable to select any one cell as the synchronization source.

In the embodiment of the present disclosure, in the case where the first terminal device is unable to detect a signal from any one cell, the first terminal device determines that the first terminal device is unable to select any one cell as the synchronization source. The cell may be a cell providing the SIB12 or RRC reconfiguration message, or may be a cell in a sidelink communication frequency, or may be any one cell.

By implementing the embodiment of the present disclosure, in response to the first terminal device having selected the relay terminal device to perform the sidelink communication, receiving the information indicating that the synchronization source is the base station, and the first terminal device being unable to select any one cell as the synchronization source, the first terminal device determines that the target synchronization source is a second terminal device or a GNSS, where the second terminal device is an on-network terminal device. Therefore, the first terminal device may maintain the synchronization with the second terminal device or the GNSS that is the on-network terminal device during the sidelink communication, which can avoid the failure of the sidelink communication.

Referring to FIG. 8, FIG. 8 is a flowchart of still another synchronization source selection method provided by an embodiment of the present disclosure.

As shown in FIG. 8, the method is performed by a first terminal device, and the method may include but is not limited to the following step S81.

At step S81, in response to receiving the information indicating that the synchronization source of a specific frequency is the base station, the first terminal device determines that the target synchronization source is the second terminal device or the GNSS, where the second terminal device is an on-network terminal device.

The method of the first terminal device determining that the second terminal device is an on-network terminal device may refer to related descriptions in the embodiments, and will be not repeated herein again.

The first terminal device determines to perform the sidelink communication, and the first terminal device may be the remote terminal device or the relay terminal device. In the case where the first terminal device is the relay terminal device, the first terminal device may directly obtain information indicating that the synchronization source of the specific frequency is the base station from the base station. In the case where the first terminal device is the remote terminal device, the first terminal device in the connected state may directly obtain the information indicating that the synchronization source of the specific frequency is the base station from the base station, or the first terminal device in the non-connected state may obtain the information for the base station indicating that the synchronization source of the specific frequency is the base station from the relay terminal device.

In some embodiments, the first terminal device receives the SIB12 or the RRC reconfiguration message sent by the base station, where the SIB12 or the RRC reconfiguration message indicates that the synchronization source of the specific frequency is the base station; and the first terminal device determines, according to the SIB12 or the RRC reconfiguration message, that the information indicating that the synchronization source of the specific frequency is the base station is received.

In the embodiment of the present disclosure, the first terminal device receives the SIB12 sent by the base station, and determines, according to the SIB12, that the information indicating that the synchronization source of the specific frequency is the base station is received.

In the embodiment of the present disclosure, the first terminal device receives the RRC reconfiguration message sent by the base station, and determines, according to the RRC reconfiguration message, that the information indicating that the synchronization source of the specific frequency is the base station is received.

By implementing the embodiment of the present disclosure, in response to receiving the information indicating that the synchronization source of a specific frequency is the base station, the first terminal device determines that the target synchronization source is the second terminal device or the GNSS, where the second terminal device is an on-network terminal device. Therefore, the first terminal device may maintain the synchronization with the second terminal device or the GNSS that is the on-network terminal device during the sidelink communication, which can avoid the failure of the sidelink communication.

Referring to FIG. 9, FIG. 9 is a flowchart of still another synchronization source selection method provided by an embodiment of the present disclosure.

As shown in FIG. 9, the method is performed by a first terminal device, and the method may include but is not limited to the following step S91.

At step S91, in response to receiving the information indicating that the synchronization source of a specific frequency is the base station and the first terminal device being unable to select a corresponding cell of the specific frequency as a synchronization source, the first terminal device determines that the target synchronization source is the second terminal device or the GNSS, where the second terminal device is an on-network terminal device.

The method of the first terminal device determining that the second terminal device is an on-network terminal device may refer to related descriptions in the embodiments, and will be not repeated herein again.

The first terminal device determines to perform the sidelink communication, and the first terminal device may be the remote terminal device or the relay terminal device. In the case where the first terminal device is the relay terminal device, the first terminal device may directly obtain information indicating that the synchronization source is the base station from the base station. In the case where the first terminal device is the remote terminal device, the first terminal device in the connected state may directly obtain the information indicating that the synchronization source is the base station from the base station, or the first terminal device in the non-connected state may obtain the information for the base station indicating that the synchronization source is the base station from the relay terminal device.

In some embodiments, the first terminal device receives the SIB12 or the RRC reconfiguration message sent by the base station, where the SIB12 or the RRC reconfiguration message indicates that the synchronization source of the specific frequency is the base station; and the first terminal device determines, according to the SIB12 or the RRC reconfiguration message, that the information indicating that the synchronization source is the base station is received.

In the embodiment of the present disclosure, the first terminal device receives the SIB12 sent by the base station, and determines, according to the SIB12, that the information indicating that the synchronization source is the base station is received.

In the embodiment of the present disclosure, the first terminal device receives the RRC reconfiguration message sent by the base station, and determines, according to the RRC reconfiguration message, that the information indicating that the synchronization source is the base station is received.

The first terminal device may determine, based on the indication from the base station, that the synchronization source of the specific frequency is the base station, and select a cell of the specific frequency as the synchronization source.

In the embodiment of the present disclosure, when the first terminal device performs the sidelink communication, the first terminal device needs to select a cell of the specific frequency as a synchronization source; and if the first terminal device is unable to select any one cell of the specific frequency as the synchronization source, the first terminal device may determine that the target synchronization source is the second terminal device or the GNSS.

In some embodiments, in response to the first terminal device being unable to detect a signal from any one cell, the first terminal device determines that the first terminal device is unable to select any one cell as the synchronization source.

In the embodiment of the present disclosure, in the case where the first terminal device is unable to detect a signal from any one cell of the specific frequency, the first terminal device determines that the first terminal device is unable to select any one cell of the specific frequency as the synchronization source. The cell may be a cell providing the SIB12 or RRC reconfiguration message, or may be a cell in a sidelink communication frequency, or may be any one cell.

By implementing the embodiment of the present disclosure, in response to receiving the information indicating that the synchronization source of a specific frequency is the base station and the first terminal device being unable to select a corresponding cell of the specific frequency as a synchronization source, the first terminal device determines that the target synchronization source is the second terminal device or the GNSS, where the second terminal device is an on-network terminal device. Therefore, the first terminal device may maintain the synchronization with the second terminal device or the GNSS that is the on-network terminal device during the sidelink communication, which can avoid the failure of the sidelink communication.

Referring to FIG. 10, FIG. 10 is a flowchart of still another synchronization source selection method provided by an embodiment of the present disclosure.

As shown in FIG. 10, the method is performed by a first terminal device, and the method may include but is not limited to the following step S101.

At step S101, in response to receiving the information indicating that the synchronization source of a specific frequency is the base station, the first terminal device determines that the target synchronization source is the second terminal device or the GNSS, where the second terminal device is an on-network terminal device.

In the embodiment of the present disclosure, in the case where the first terminal device determines to perform the sidelink communication and has selected the relay terminal device, the second terminal device may be a relay terminal device.

The method of the first terminal device determining that the second terminal device is an on-network terminal device may refer to related descriptions in the embodiments, and will be not repeated herein again.

The first terminal device determines to perform the sidelink communication, and the first terminal device has selected the relay terminal device, and the first terminal device may be the remote terminal device. In the case where the first terminal device is the remote terminal device, the first terminal device in the connected state may directly obtain the information indicating that the synchronization source of a specific frequency is the base station from the base station, or the first terminal device in the non-connected state may obtain the information for the base station indicating that the synchronization source of the specific frequency is the base station from the relay terminal device.

In some embodiments, the first terminal device receives the SIB12 or the RRC reconfiguration message sent by the base station, where the SIB12 or the RRC reconfiguration message indicates that the synchronization source is the base station; and the first terminal device determines, according to the SIB12 or the RRC reconfiguration message, that the information indicating that the synchronization source of the specific frequency is the base station is received.

In the embodiment of the present disclosure, the first terminal device receives the SIB12 sent by the base station, and determines, according to the SIB12, that the information indicating that the synchronization source of the specific frequency is the base station is received.

In the embodiment of the present disclosure, the first terminal device receives the RRC reconfiguration message sent by the base station, and determines, according to the RRC reconfiguration message, that the information indicating that the synchronization source of the specific frequency is the base station is received.

By implementing the embodiment of the present disclosure, in response to the first terminal device receiving the information indicating that the synchronization source of a specific frequency is the base station, the first terminal device determines that the target synchronization source is the second terminal device or the GNSS, where the second terminal device is an on-network terminal device. Therefore, the first terminal device may maintain the synchronization with the second terminal device or the GNSS that is the on-network terminal device during the sidelink communication, which can avoid the failure of the sidelink communication.

Referring to FIG. 11, FIG. 11 is a flowchart of still another synchronization source selection method provided by an embodiment of the present disclosure.

As shown in FIG. 11, the method is performed by a first terminal device, and the method may include but is not limited to the following step S111.

At step S111, in response to receiving the information indicating that the synchronization source of a specific frequency is the base station and the first terminal device being unable to select any one cell of the specific frequency as a synchronization source, it is determined that the target synchronization source is the second terminal device or the GNSS, where the second terminal device is an on-network terminal device.

In the embodiment of the present disclosure, in the case where the first terminal device determines to perform the sidelink communication and has selected the relay terminal device, the second terminal device may be a relay terminal device.

The method of the first terminal device determining that the second terminal device is an on-network terminal device may refer to related descriptions in the embodiments, and will be not repeated herein again.

The first terminal device determines to perform the sidelink communication, and the first terminal device has selected the relay terminal device, and the first terminal device may be the remote terminal device. In the case where the first terminal device is the remote terminal device, the first terminal device in the connected state may directly obtain the information indicating that the synchronization source of a specific frequency is the base station from the base station, or the first terminal device in the non-connected state may obtain the information for the base station indicating that the synchronization source of the specific frequency is the base station from the relay terminal device.

In some embodiments, the first terminal device receives the SIB12 or the RRC reconfiguration message sent by the base station, where the SIB12 or the RRC reconfiguration message indicates that the synchronization source is the base station; and the first terminal device determines, according to the SIB12 or the RRC reconfiguration message, that the information indicating that the synchronization source of the specific frequency is the base station is received.

In the embodiment of the present disclosure, the first terminal device receives the SIB12 sent by the base station, and determines, according to the SIB12, that the information indicating that the synchronization source of the specific frequency is the base station is received.

In the embodiment of the present disclosure, the first terminal device receives the RRC reconfiguration message sent by the base station, and determines, according to the RRC reconfiguration message, that the information indicating that the synchronization source of the specific frequency is the base station is received.

The first terminal device may determine, based on the indication from the base station, that the synchronization source of the specific frequency is the base station, and select a cell of the specific frequency as the synchronization source.

In the embodiment of the present disclosure, when the first terminal device performs the sidelink communication, the first terminal device needs to select a cell of the specific frequency as a synchronization source; and if the first terminal device is unable to select any one cell of the specific frequency as the synchronization source, the first terminal device may determine that the target synchronization source is the second terminal device or the GNSS.

In some embodiments, in response to the first terminal device being unable to detect a signal from any one cell, the first terminal device determines that the first terminal device is unable to select any one cell as the synchronization source.

In the embodiment of the present disclosure, in the case where the first terminal device is unable to detect a signal from any one cell of the specific frequency, the first terminal device determines that the first terminal device is unable to select any one cell of the specific frequency as the synchronization source. The cell may be a cell providing the SIB12 or RRC reconfiguration message, or may be a cell in a sidelink communication frequency, or may be any one cell.

By implementing the embodiment of the present disclosure, in response to receiving the information indicating that the synchronization source of a specific frequency is the base station and the first terminal device being unable to select a corresponding cell of the specific frequency as a synchronization source, the first terminal device determines that the target synchronization source is the second terminal device or the GNSS, where the second terminal device is an on-network terminal device. Therefore, the first terminal device may maintain the synchronization with the second terminal device or the GNSS that is the on-network terminal device during the sidelink communication, which can avoid the failure of the sidelink communication.

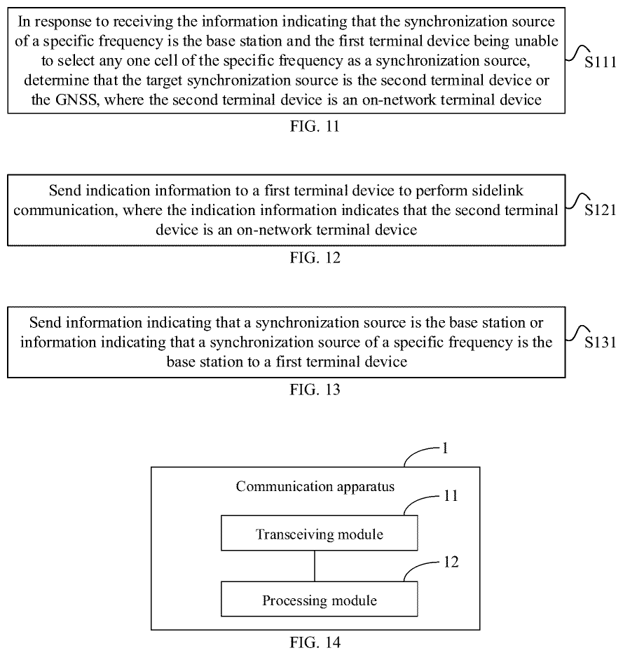

Referring to FIG. 12, FIG. 12 is a flowchart of still another synchronization source selection method provided by an embodiment of the present disclosure.

As shown in FIG. 12, the method is performed by a second terminal device, and the method may include but is not limited to the following step S121.

At step S121, indication information is sent to a first terminal device for performing sidelink communication, where the indication information indicates that the second terminal device is an on-network terminal device.

In the embodiment of the present disclosure, the second terminal device may send indication information to the first terminal device, where the indication information indicates that the second terminal device is an on-network terminal device.

In some embodiments, the second terminal device may further send information to instruct the first terminal device to determine a target synchronization source, where the target synchronization source is the second terminal device or a GNSS.

Based on this, the indication information may be configured for the first terminal device to determine that the second terminal device is an on-network terminal device, and determine that the target synchronization source is the second terminal device or the GNSS in the case where the first terminal device determines to perform the sidelink communication.

By implementing the embodiment of the present disclosure, the second terminal device sends indication information to the first terminal device, where the indication information indicates that the second terminal device is within a network coverage range, and the indication information is configured for the first terminal device to determine that the second terminal device is an on-network terminal device, and determine that the target synchronization source is the second terminal device or the GNSS in the case where the first terminal device determines to perform the sidelink communication. Therefore, the first terminal device may maintain the synchronization with the second terminal device or the GNSS that is the on-network terminal device during the sidelink communication, which can avoid the failure of the sidelink communication.

Referring to FIG. 13, FIG. 13 is a flowchart of still another synchronization source selection method provided by an embodiment of the present disclosure.

As shown in FIG. 13, the method is performed by a base station, and the method may include but is not limited to the following step S131.

At step S131, information indicating that a synchronization source is the base station or information indicating that a synchronization source of a specific frequency is the base station is sent to a first terminal device.

The base station may send a message to the first terminal device, where the message indicates that the synchronization source is the base station or a synchronization source of a specific frequency.

For example, the message may be an SIB12 or an RRC reconfiguration message.

For example, the message indicates that the synchronization source is the base station, or the synchronization source of the specific frequency is the base station.

The information indicating that the synchronization source is the base station or the information indicating that the synchronization source of the specific frequency is the base station is configured for the first terminal device to determine a target synchronization source for performing sidelink communication, where the target synchronization source is a second terminal device or a GNSS, and the second terminal device is an on-network terminal device.

In some implementations, in response to the first terminal device having selected the relay terminal device, the first terminal device determines that the target synchronization source is the second terminal device or the GNSS; or, in response to the message indicating that the synchronization source is the base station, the first terminal device determines that the target synchronization source is the second terminal device or the GNSS; or, in response to the first terminal device being unable to select any one cell as the synchronization source, the first terminal device determines that the target synchronization source is the second terminal device or the GNSS; or, in response to receiving the information indicating that the synchronization source is the base station, and the first terminal device being unable to select any one corresponding cell as the synchronization source, the first terminal device determines that the target synchronization source is the second terminal device or the GNSS; or, in response to receiving the information indicating that a synchronization source of a specific frequency is the base station, and the first terminal device being unable to select a corresponding cell as the synchronization source, the first terminal device determines that the target synchronization source is the second terminal device or the GNSS; or, in response to the first terminal device being unable to select a corresponding cell of a specific frequency as the synchronization source, the first terminal device determines that the target synchronization source is the second terminal device or the GNSS; or, in response to the message indicating that the synchronization source of the specific frequency is the base station and the first terminal device being unable to select the corresponding cell of the specific frequency as the synchronization source, the first terminal device determines that the target synchronization source is the second terminal device or the GNSS; or, in response to the first terminal having selected the relay terminal device as the synchronization source, receiving the information indicating that the synchronization source of the specific frequency is the base station, and the first terminal device being unable to select a corresponding cell of the specific frequency as the synchronization source, the first terminal device determines that the target synchronization source is the second terminal device or the GNSS.

It should be noted that the embodiments are not exhaustive, and are merely examples of some embodiments, and the embodiments may be implemented separately, or may be implemented through combination of multiple embodiments. The embodiments are only for illustration and do not serve as specific limitations on the scope of protection of the disclosed embodiments.

Based on this, the SIB12 or RRC reconfiguration message may be configured for the first terminal device to determine that a first base station indicates that the synchronization source is the base station, and determine that the target synchronization source is the second terminal device or the GNSS, in the case of being unable to select any one cell as the synchronization source.

The cell may be a cell providing the SIB12 or RRC reconfiguration message, or may be a cell in a sidelink communication frequency, or may be any one cell.

In some embodiments, the first base station may further send the SIB12 or RRC reconfiguration message to the first terminal device, where the SIB12 or RRC reconfiguration message indicates that the synchronization source of the specific frequency is the base station.

Based on this, the SIB12 or RRC reconfiguration message may be configured for the first terminal device to determine that a first base station indicates that the synchronization source of the specific frequency is the base station, and determine that the target synchronization source is the second terminal device or the GNSS, in the case of being unable to select any one cell as the synchronization source.

By implementing the embodiment of the present disclosure, the first base station sends the SIB12 or RRC reconfiguration message to the first terminal device, where the SIB12 or RRC reconfiguration message indicates that the synchronization source is the base station, and the SIB12 or RRC reconfiguration message is configured for the first terminal device to determine that the first base station indicates that the synchronization source is the base station, and determine that the target synchronization source is the second terminal device or the GNSS, in the case of being unable to select any one cell as the synchronization source. Therefore, the first terminal device may maintain the synchronization with the second terminal device or the GNSS that is the on-network terminal device during the sidelink communication, which can avoid the failure of the sidelink communication.

In the embodiments provided by the present disclosure, the methods provided by the embodiments of the present disclosure is introduced from the perspectives of the first terminal device, the second terminal device, and the base station respectively.

Referring to FIG. 14, FIG. 14 is a schematic structural diagram of a communication apparatus 1 provided by an embodiment of the present disclosure. The communication apparatus 1 shown in FIG. 14 may include a transceiving module 11 and a processing module 12. The transceiving module may include a transmitting module and/or a receiving module (not shown). The transmitting module is configured to implement a transmitting function, the receiving module is configured to implement a receiving function, and the transceiving module may implement the transmitting function and/or the receiving function.

The communication apparatus 1 is configured in the first terminal device.

The apparatus 1 includes a processing module 12.

The processing module 12 is configured to determine a target synchronization source for performing sidelink communication, where the target synchronization source is a second terminal device or a global navigation satellite system (GNSS), and the second terminal device is an on-network terminal device.

In some embodiments, the processing module 12 is further configured to determine the target synchronization source for performing the sidelink communication in response to meeting at least one of following conditions: the first terminal device having selected a relay terminal device; receiving information indicating that a synchronization source is a base station; the first terminal device being unable to select any one cell as a synchronization source; receiving information indicating that a synchronization source of a specific frequency is a base station; or the first terminal device being unable to select any one cell of a specific frequency as a synchronization source.

In some embodiments, as shown in FIG. 14, the apparatus 1 further includes a transceiving module 11.

The transceiving module 11 is configured to receive indication information sent by the second terminal device, where the indication information indicates that the second terminal device is within a network coverage range.

The processing module 12 is further configured to determine, according to the indication information, that the second terminal device is the on-network terminal device.

In some embodiments, the second terminal device is a relay terminal device.

In some embodiments, the processing module 12 is further configured to determine, in response to the first terminal device being unable to detect a signal from any one cell, that the first terminal device is unable to select any one cell as the synchronization source.

In some embodiments, the transceiving module 11 is further configured to receive a system signal block (SIB12) or a radio resource control (RRC) reconfiguration message sent by the base station, where the SIB12 or the RRC reconfiguration message indicates that the synchronization source is the base station.

In some embodiments, the transceiving module 11 is further configured to receive a system signal block (SIB12) or a radio resource control (RRC) reconfiguration message sent by the base station, where the SIB12 or the RRC reconfiguration message indicates that the synchronization source of the specific frequency is the base station.

In some embodiments, the processing module 12 is further configured to determine, in response to synchronization between the first terminal device and the second terminal device, to maintain the synchronization with a cell.

In some embodiments, the cell is a serving cell for the second terminal device.

The communication apparatus 1 is configured in the second terminal device.

The apparatus 1 includes a transceiving module 11.

The transceiving module 11 is configured to send indication information to a first terminal device, where the indication information indicates that the second terminal device is within a network coverage range, and the indication information is configured for the first terminal device to determine that the second terminal device is an on-network terminal device.

The communication apparatus 1 is configured in the base station.

The apparatus 1 includes a transceiving module 11.

The transceiving module 11 is configured to send, to a first terminal device, information indicating that a synchronization source is the base station or information indicating that a synchronization source of a specific frequency is the base station; where the information indicating that the synchronization source is the base station or the information indicating that the synchronization source of the specific frequency is the base station is configured for the first terminal device to determine a target synchronization source for performing sidelink communication, where the target synchronization source is a second terminal device or a global navigation satellite system (GNSS), and the second terminal device is an on-network terminal device.

The specific manners in which each of the modules of the communication apparatus 1 in the embodiments performs operations have been described in detail in the embodiments related to the method, and will not be explained here in detail.

The communication apparatus 1 provided in the embodiment of the present disclosure achieves same or similar beneficial effects as the synchronization source selection method provided in the some embodiments, which will be not repeated herein.

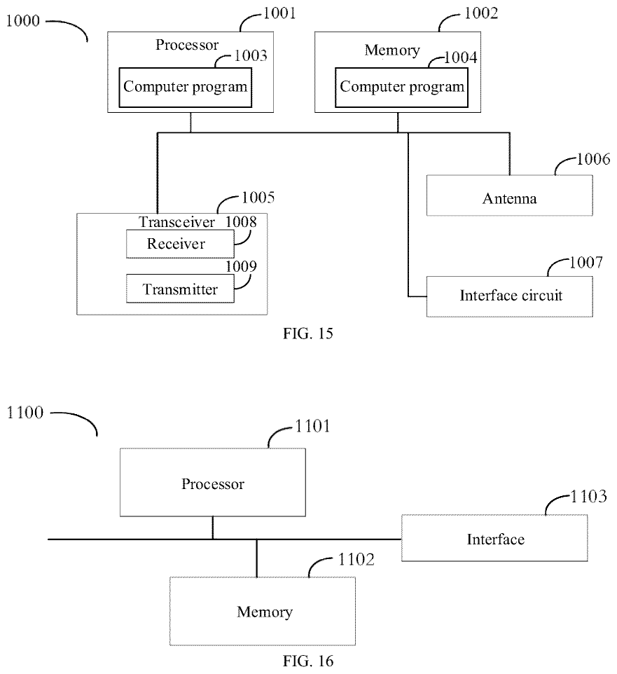

Referring to FIG. 15, FIG. 15 is a schematic structural diagram of another communication apparatus 1000 provided by an embodiment of the present disclosure. The communication apparatus 1000 may be a terminal device or a network side device. The communication apparatus 1000 may also be a chip, a chip system, or a processor that supports the terminal device to implement the methods, etc. The communication apparatus 1000 may also be a chip, a chip system, or a processor that supports the network side device to implement the methods, etc. The communication apparatus 1000 may be configured to implement the methods described in the method embodiments, which may specifically refer to the description in the method embodiments.

The communication apparatus 1000 may include one or more processors 1001. The processors 1001 may be general-purpose processors, special-purpose processors, etc. For example, the processors may be baseband processors or central processing units. The baseband processor may be used to process a communication protocol and communication data, and the central processing unit may be used to control the communication apparatus (for example, a network side device, a baseband chip, a terminal device, a terminal device chip, a DU, a CU, etc.), execute a computer program, and process data of the computer program.

Optionally, the communication apparatus 1000 may further include one or more memories 1002. The one or more memories 1002 may store a computer program 1004, and the processors 1001 execute the computer program 1004 to cause the communication apparatus 1000 to perform the methods described in the method embodiments. Optionally, the memories 1002 may further store data. The communication apparatus 1000 and the memories 1002 may be separately configured, or may be integrated together.

Optionally, the communication apparatus 1000 may further include a transceiver 1005 and an antenna 1006. The transceiver 1005 may be referred to as a transceiving unit, a transceiving machine, a transceiving circuit, etc., and is configured to implement a transceiving function. The transceiver 1005 may include a receiver 1008 and a transmitter 1009. The receiver 1008 may be referred to as a receiving machine, a receiving circuit, etc., and is configured to implement a receiving function. The transmitter 1009 may be referred to as a transmitting machine, a transmitting circuit, etc., and is configured to implement a transmitting function.

Optionally, the communication apparatus 1000 may further include one or more interface circuits 1007. The interface circuits 1007 are configured to receive code instructions and transmitting the code instructions to the processor 1001. The processor 1001 executes the code instructions to cause the communication apparatus 1000 to perform the methods described in the method embodiments.

The communication apparatus 1000 is the first terminal device. The processor 1001 is configured to perform the step S21 in FIG. 2, the step S31 in FIG. 3, the step S41 in FIG. 4, the step S51 in FIG. 5, the step S61 in FIG. 6, the step S71 in FIG. 7, the step S81 in FIG. 8, the step S91 in FIG. 9, the step S101 in FIG. 10, and the step S111 in FIG. 11.

The communication apparatus 1000 is the second device, and the transceiver 1005 is configured to perform step 121 in FIG. 12.

The communication apparatus 1000 is the base station, and the transceiver 1005 is configured to perform step 131 in FIG. 13.

In an implementation, the processor 1001 may include a transceiver for implementing the receiving and transmitting functions. For example, the transceiver may be a transceiving circuit, an interface, or an interface circuit. The transceiving circuit, the interface, or the interface circuit for implementing the receiving and transmitting functions may be separate or integrated together. The transceiving circuit, the interface, or the interface circuit may be used to read and write codes/data, or the transceiving circuit, the interface, or the interface circuit may be used to transmit or transfer a signal.

In an implementation, the processor 1001 may store a computer program 1003, and the computer program 1003 is performed by the processor 1001, so that the communication apparatus 1000 may perform the methods described in the method embodiments. The computer program 1003 may be fixed in the processor 1001, and in this case, the processor 1001 may be implemented by hardware.

In an implementation, the communication apparatus 1000 may include a circuit, and the circuit may implement sending, receiving, or communicating functions in the method embodiments. The processor and transceiver described in the present disclosure may be implemented on integrated circuits (ICs), analog ICs, radio frequency integrated circuits (RFICs), mixed signal ICs, application specific integrated circuits (ASICs), printed circuit boards (PCBs), electronic devices, etc. The processor and transceiver may also be fabricated with various IC process technologies, such as a complementary metal oxide semiconductor (CMOS), an n-metal oxide semiconductor (NMOS), a p-metal oxide semiconductor (positive channel metal oxide semiconductor, PMOS), a bipolar junction transistor (BJT), a bipolar CMOS (BiCMOS), a silicon germanium (SiGe), a gallium arsenide (GaAs), etc.

The communication apparatus described in the embodiments may be a terminal device or a network side device, but a scope of the communication apparatus described in the present disclosure is not limited thereto, and a structure of the communication apparatus may not be limited by FIG. 15. The communication apparatus may be a separate device or may be a part of a larger device. For example, the communication apparatus may be: (1) a separate integrated circuit (IC), chip, or chip system or subsystem; (2) a set of one or more ICs; optionally, the set of ICs may also include a storage component for storing data and a computer program; (3) an ASIC, for example, a modem; (4) a module that may be embedded within other devices; (5) a receiving machine, a terminal device, an intelligent terminal device, a cellular phone, a wireless device, a handset, a mobile unit, an in-vehicle device, a network device, a cloud device, an artificial intelligence device, etc.; or (6) other apparatus, etc.

For a case in which the communication apparatus may be a chip or a chip system, referring to FIG. 16, FIG. 16 is a structural diagram of a chip provided in an embodiment of the present disclosure.

The chip 1100 shown includes a processor 1101 and an interface 1103. There may be one or more processors 1101, and there may be multiple interfaces 1103.

For the case in which the chip 1100 is configured to implement functions of the first terminal device in the embodiments of the present disclosure, the interface 1103 is configured to receive code instructions and transmit the code instructions to the processor; and the processor 1101 is configured to perform the code instructions to perform the synchronization source selection method in the embodiments.

For the case in which the chip 1100 is configured to implement functions of the second terminal device in the embodiments of the present disclosure, the interface 1103 is configured to receive code instructions and transmit the code instructions to the processor; and the processor 1101 is configured to perform the code instructions to perform the synchronization source selection method in the embodiments.

For the case in which the chip 1100 is configured to implementing functions of the base station in the embodiments of the present disclosure, the interface 1103 is configured to receive code instructions and transmit the code instructions to the processor; and the processor 1101 is configured to perform the code instructions to perform the synchronization source selection method in the embodiments.

Optionally, the chip 1100 further includes a memory 1102, and the memory 1102 is configured to store a necessary computer program and data.

Those skilled in the art may also understand that various illustrative logical blocks and steps listed in the embodiments of the present disclosure may be implemented by using electronic hardware, computer software, or a combination of the two. Whether such function is implemented by hardware or software depends on specific applications and design requirements of an overall system. Those skilled in the art may use various methods to implement the functions for each specific application, but this implementation should not be understood as going beyond the protection scope of the embodiments of the present disclosure.

An embodiment of the present disclosure further provides a synchronization source selection system. The system includes the communication apparatus as the first terminal device, the communication apparatus as the second terminal device, and the communication apparatus as the base station in the embodiment of FIG. 14, or the system includes the communication apparatus as the first terminal device, the communication apparatus as the second terminal device, and the communication apparatus as the base station in the embodiment of FIG. 15.

The present disclosure further provides a non-transitory computer-readable storage medium for storing instructions. When the instructions are executed by a computer, functions of any one of the method embodiments are implemented.

The present disclosure further provides a computer program product. When the computer program product is executed by a computer, the functions of any one of the method embodiments are implemented.

In a first aspect, an embodiment of the present disclosure provides a synchronization source selection method. The method is performed by a first terminal device, and includes: determining a target synchronization source for performing sidelink communication, where the target synchronization source is a second terminal device or a global navigation satellite system (GNSS), and the second terminal device is an on-network terminal device.

In this technical solution, the first terminal device determines a target synchronization source for performing sidelink communication, where the target synchronization source is a second terminal device or a global navigation satellite system (GNSS), and the second terminal device is an on-network terminal device. Therefore, the first terminal device may maintain the synchronization with the second terminal device or the GNSS that is the on-network terminal device during the sidelink communication, which can avoid the failure of the sidelink communication.

In a second aspect, an embodiment of the present disclosure provides another synchronization source selection method. The method is performed by a second terminal device, and includes: sending indication information to a first terminal device, where the indication information indicates that the second terminal device is within a network coverage range, and the indication information is configured for the first terminal device to determine that the second terminal device is an on-network terminal device.

In a third aspect, an embodiment of the present disclosure provides still another synchronization source selection method. The method is performed by a base station, and includes: sending, to a first terminal device, information indicating that a synchronization source is the base station or information indicating that a synchronization source of a specific frequency is the base station; where the information indicating that the synchronization source is the base station or the information indicating that the synchronization source of the specific frequency is the base station is configured for the first terminal device to determine a target synchronization source for performing sidelink communication, the target synchronization source is a second terminal device or a global navigation satellite system (GNSS), and the second terminal device is an on-network terminal device.

In a fourth aspect, an embodiment of the present disclosure provides a communication apparatus. The communication apparatus has a part or all of functions of the terminal device implementing the method in the above first aspect. For example, functions of the communication apparatus may have functions in a part or all of the embodiments of the present disclosure, or may have functions separately implementing any embodiment of the present disclosure. The functions may be implemented by hardware, or may be implemented by hardware executing corresponding software. The hardware or software includes one or more units or modules corresponding to the above functions.

In an implementation, a structure of the communication apparatus may include a transceiving module and a processing module, and the processing module is configured to support the communication apparatus to perform a corresponding function in the above method. The transceiving module is configured to support communication between the communication apparatus and other devices. The communication apparatus may further include a storage module, where the storage module is configured to be coupled to the transceiving module and a processing module, and stores a computer program and data that are necessary for the communication apparatus.

In an implementation, the communication apparatus includes: a processing module, configured to determine a target synchronization source for performing sidelink communication, where the target synchronization source is a second terminal device or a global navigation satellite system (GNSS), and the second terminal device is an on-network terminal device.

In a fifth aspect, an embodiment of the present disclosure provides another communication apparatus. The communication apparatus has a part or all of functions of the second terminal device implementing the method example in the above second aspect. For example, functions of the communication apparatus may have functions in a part or all of the embodiments of the present disclosure, or may have functions separately implementing any embodiment of the present disclosure. The functions may be implemented by hardware, or may be implemented by hardware executing corresponding software. The hardware or software includes one or more units or modules corresponding to the above functions.

In an implementation, a structure of the communication apparatus may include a transceiving module and a processing module, and the processing module is configured to support the communication apparatus to perform a corresponding function in the above method. The transceiving module is configured to support communication between the communication apparatus and other devices. The communication apparatus may further include a storage module, where the storage module is configured to be coupled to the transceiving module and a processing module, and stores a computer program and data that are necessary for the communication apparatus.

In an implementation, the communication apparatus includes: a transceiving module, configured to send indication information to a first terminal device, where the indication information indicates that the second terminal device is within a network coverage range, and the indication information is configured for the first terminal device to determine that the second terminal device is an on-network terminal device.

In a sixth aspect, an embodiment of the present disclosure provides another communication apparatus. The communication apparatus has a part or all of functions of the base station implementing the method example in the above third aspect. For example, functions of the communication apparatus may have functions in a part or all of the embodiments of the present disclosure, or may have functions separately implementing any embodiment of the present disclosure. The functions may be implemented by hardware, or may be implemented by hardware executing corresponding software. The hardware or software includes one or more units or modules corresponding to the above functions.

In an implementation, a structure of the communication apparatus may include a transceiving module and a processing module, and the processing module is configured to support the communication apparatus to perform a corresponding function in the above method. The transceiving module is configured to support communication between the communication apparatus and other devices. The communication apparatus may further include a storage module, where the storage module is configured to be coupled to the transceiving module and a processing module, and stores a computer program and data that are necessary for the communication apparatus.

In an implementation, the communication apparatus includes: a transceiving module, configured to send, to a first terminal device, information indicating that a synchronization source is the base station or information indicating that a synchronization source of a specific frequency is the base station; where the information indicating that the synchronization source is the base station or the information indicating that the synchronization source of the specific frequency is the base station is configured for the first terminal device to determine a target synchronization source for performing sidelink communication, where the target synchronization source is a second terminal device or a global navigation satellite system (GNSS), and the second terminal device is an on-network terminal device.

In a seventh aspect, an embodiment of the present disclosure provides a communication apparatus. The communication apparatus includes a processor, and the processor, when invoking a computer program in a memory, performs the method in the first or second aspect.

In an eighth aspect, an embodiment of the present disclosure provides a communication apparatus. The communication apparatus includes a processor, and the processor, when invoking a computer program in a memory, performs the method in the third aspect.

In a ninth aspect, an embodiment of the present disclosure provides a communication apparatus. The communication apparatus includes a processor and a memory, the memory stores a computer program, and the processor executes the computer program stored in the memory, to cause the communication apparatus to perform the method in the first or second aspect.

In a tenth aspect, an embodiment of the present disclosure provides a communication apparatus. The communication apparatus includes a processor and a memory, the memory stores a computer program, and the processor executes the computer program stored in the memory, to cause the communication apparatus to perform the method in the third aspect.

In an eleventh aspect, an embodiment of the present disclosure provides a communication apparatus. The apparatus includes a processor and an interface circuit. The interface circuit is configured to receive code instructions and transmitting the code instructions to the processor, and the processor is configured to execute the code instructions to cause the apparatus to perform the method in the first or second aspect.

In a twelfth aspect, an embodiment of the present disclosure provides a communication apparatus. The apparatus includes a processor and an interface circuit. The interface circuit is configured to receive code instructions and transmitting the code instructions to the processor, and the processor is configured to execute the code instructions to cause the apparatus to perform the method in the third aspect.

In a thirteenth aspect, an embodiment of the present disclosure provides a synchronization source selection system. The system includes the communication apparatus in the fourth aspect, the communication apparatus in the fifth aspect, and the communication apparatus in the sixth aspect, or the system includes the communication apparatus in the seventh aspect and the communication apparatus in the eighth aspect, or the system includes the communication apparatus in the ninth aspect and the communication apparatus in the tenth aspect, or the system includes the communication apparatus in the eleventh aspect and the communication apparatus in the twelfth aspect.

In a fourteenth aspect, an embodiment of the present disclosure provides a non-transitory computer-readable storage medium, configured to store instructions used for the above terminal device. When the instructions are executed, the terminal device performs the method in the first or second aspect.

In a fifteenth aspect, an embodiment of the present disclosure provides a non-transitory computer-readable storage medium, configured to store instructions used for the above base station. When the instructions are executed, the base station performs the method in the third aspect.

In a sixteenth aspect, the present disclosure further provides a computer program product including a computer program. When the computer program is executed by a computer, the computer performs the method in the first or second aspect.

In a seventeenth aspect, the present disclosure further provides a computer program product including a computer program. When the computer program is executed by a computer, the computer performs the method in the third aspect.

In an eighteenth aspect, the present disclosure provides a chip system. The chip system includes at least one processor and an interface, and is configured to support the terminal device to implement the functions involved in the first or second aspect, for example, determining or processing at least one of data and information involved in the above method. In a possible design, the chip system further includes a memory, and the memory is configured to store a computer program and data that are necessary for the terminal device. The chip system may be composed of a chip, or may include a chip and other discrete components.

In a nineteenth aspect, the present disclosure provides a chip system. The chip system includes at least one processor and an interface, and is configured to support the base station to implement the functions involved in the third aspect, for example, determining or processing at least one of data and information involved in the above method. In a possible design, the chip system further includes a memory, and the memory is configured to store a computer program and data that are necessary for the base station. The chip system may be composed of a chip, or may include a chip and other discrete components.

In a twentieth aspect, the present disclosure provides a computer program. When the computer program is executed by a computer, the computer performs the method in the first or second aspect.

In a twenty-first aspect, the present disclosure provides a computer program. When the computer program is executed by a computer, the computer performs the method in the third aspect.

In the embodiments, it may be implemented in whole or in part by software, hardware, firmware, or any combination thereof. When implemented in software, it may be implemented in whole or in part in the form of a computer program product. The computer program product includes one or more computer programs. When the computer programs are loaded and executed by a computer, the processes or functions according to embodiments of the present disclosure are generated in whole or in part. The computer may be a general purpose computer, a special purpose computer, a computer network, or other programmable apparatus. The computer programs may be stored in a non-transitory computer readable storage medium or transmitted from one non-transitory computer readable storage medium to another non-transitory computer readable storage medium. For example, the computer programs may be transmitted from a website site, computer, server or data center to another website site, computer, server or data center by a wired (for example, a coaxial-cable, a fiber, a digital subscriber line (DSL)) or wirelessly (for example, infrared, wireless, microwave, etc.) manner. The non-transitory computer readable storage medium may be any available medium that can be accessed by a computer or may be a data storage device, such as a server, data center, or the like, including one or more integrated available mediums. The available medium may be a magnetic medium (for example, a floppy disk, a hard disk, a magnetic tape), an optical medium (for example, a digital video disc (DVD)), or a semiconductor medium (for example, a solid state disk (SSD)), etc.

Those skilled in the art may understand that various numerical numbers such as “first” and “second” involved in the present disclosure are only for distinguishing for the convenience of description and are not intended to limit the scope of the embodiments of the present disclosure, and do not also represent an early-later sequence.

“At least one” in the present disclosure may also be described as one or more, and “a plurality of/multiple” may be two, three, four or more, which is not limited in the present disclosure. In the embodiments of the present disclosure, for a kind of technical features, technical features in the kind of technical features are distinguished by “first”, “second”, “third”, “A”, “B”, “C”, and “D”, etc., and there is no an early-later sequence or a large-small sequence among the technical features described by “first”, “second”, “third”, “A”, “B”, “C”, and “D”.

The correspondence relationships shown in each table in the present disclosure may be configured or predefined. Values of the information in each table are merely examples, and may be configured as other values, which is not limited in the present disclosure. When configuring correspondence relationships between the information and each parameter, it is not necessarily required to configure all the correspondence relationships shown in each table. For example, correspondence relationships shown in certain rows may also not be configured in the tables in the present disclosure. For another example, appropriate deformation adjustment may be performed based on the above tables, for example, splitting, merging, etc. A name of a parameter shown by a title in each of the above tables may also be another name of the communication apparatus that may be understood, and a value or a representation manner of the parameter may also be another value or representation manner of the communication apparatus that may be understood. During implementation of each of the above tables, other data structures may also be used, for example, an array, a queue, a container, a stack, a linear table, a pointer, a linked list, a tree, a graph, a structure body, a class, a heap, a hashing table of a hash table, etc., may be used.

Predefinition in the present disclosure may be understood as defining, pre-defining, storing, pre-storing, pre-negotiating, pre-configuring, curing, or pre-firing.

Those skilled in the art can realize that the units and algorithm steps of each example described in connection with the embodiments disclosed herein can be implemented in electronic hardware, or a combination of computer software and electronic hardware. Whether these functions are performed in hardware or software depends on the specific application and the design constraint condition of the technical solution. Professional technicians may use different methods to implement the described functions for each specific application, but such implementation should not be considered to be beyond the scope of the present disclosure.

Those skilled in the art may clearly understand that for the convenience and conciseness of the description, the specific working processes of the system, apparatus, and unit described above may refer to the corresponding processes in the aforementioned method embodiments, and will not be repeated here.

The above description is only specific implement manner of the present disclosure, and the protection scope of the present disclosure is not limited thereto. Any alteration or substitution that can be easily conceived by any those skilled in the art within the technical scope disclosed by the present disclosure shall fall within the protection scope of the present disclosure. Therefore, the protection scope of the present disclosure shall be subject to the protection scope of the claims.

1. A synchronization source selection method, performed by a first terminal device and comprising:
determining a target synchronization source for performing sidelink communication, wherein the target synchronization source is a second terminal device or a global navigation satellite system (GNSS), and the second terminal device is an on-network terminal device.

2. The method of claim 1, wherein the determining a target synchronization source for performing sidelink communication, comprises:
determining the target synchronization source for performing the sidelink communication in response to at least one of:
determining that the first terminal device has selected a relay terminal device;
receiving information indicating that a synchronization source is a base station;
determining that the first terminal device is unable to select any one cell as a synchronization source;
receiving information indicating that a synchronization source of a specific frequency is a base station; or
determining that the first terminal device is unable to select any one cell of a specific frequency as a synchronization source.

3. The method of claim 1, further comprising:
receiving indication information sent by the second terminal device, wherein the indication information indicates that the second terminal device is within a network coverage range; and
determining, according to the indication information, that the second terminal device is the on-network terminal device.

4. The method of claim 2, wherein the second terminal device is the relay terminal device.

5. The method of claim 2, wherein the determining that the first terminal device is unable to select any one cell as a synchronization source, comprises
determining, in response to the first terminal device being unable to detect a signal from any one cell, that the first terminal device is unable to select any one cell as the synchronization source.

6. The method of claim 2, wherein the receiving information indicating that a synchronization source is a base station, comprises:
receiving a system signal block (SIB12) or a radio resource control (RRC) reconfiguration message sent by the base station, wherein the SIB12 or the RRC reconfiguration message indicates that the synchronization source is the base station.

7. The method of claim 2, wherein the receiving information indicating that a synchronization source of a specific frequency is a base station, comprises:
receiving a system signal block (SIB12) or a radio resource control (RRC) reconfiguration message sent by the base station, wherein the SIB12 or the RRC reconfiguration message indicates that the synchronization source of the specific frequency is the base station.

8. The method of claim 1, further comprising:
determining, in response to determining that the first terminal device is synchronized with the second terminal device, to maintain the synchronization with a cell.

9. The method of claim 8, wherein the cell is a serving cell for the second terminal device.

10. A synchronization source selection method, performed by a second terminal device and comprising:
sending indication information to a first terminal device, wherein the indication information indicates that the second terminal device is within a network coverage range, and the indication information is configured for the first terminal device to determine that the second terminal device is an on-network terminal device.

11. A synchronization source selection method, performed by a base station and comprising:
sending a synchronization source indication information to a first terminal device, wherein the synchronization source indication information
indicates that a synchronization source is the base station or indicates that a synchronization source of a specific frequency is the base station; wherein the synchronization source indication information is configured for the first terminal device to determine a target synchronization source for performing sidelink communication, wherein the target synchronization source is a second terminal device or a global navigation satellite system (GNSS), and the second terminal device is an on-network terminal device.

12-14. (canceled)

15. A communication apparatus, comprising: a processor and a memory, wherein the memory stores a computer program, and the processor executes the computer program stored in the memory to cause the apparatus to perform the method of claim 1.

16. A communication apparatus, comprising: a processor and an interface circuit, wherein
wherein the interface circuit is configured to receive code instructions and transmit the code instructions to the processor, and
the processor is configured to execute the code instructions to perform the method of claim 1.

17. A non-transitory computer-readable storage medium, configured to store instructions, wherein the method of claim 1 implemented when the instructions are executed.

18. A communication apparatus, comprising: a processor and a memory, wherein the memory stores a computer program, and the processor executes the computer program stored in the memory to cause the apparatus to perform the method of claim 10.

19. A communication apparatus, comprising: a processor and a memory, wherein the memory stores a computer program, and the processor executes the computer program stored in the memory to cause the apparatus to perform the method of claim 11.

20. A communication apparatus, comprising: a processor and an interface circuit, wherein
the interface circuit is configured to receive code instructions and transmit the code instructions to the processor; and
the processor is configured to execute the code instructions to perform the method of claim 10.

21. A communication apparatus, comprising: a processor and an interface circuit, wherein
the interface circuit is configured to receive code instructions and transmit the code instructions to the processor; and
the processor is configured to execute the code instructions to perform the method of claim 11.

22. A non-transitory computer-readable storage medium, configured to store instructions, wherein the method of claim 10 is implemented when the instructions are executed.

23. A non-transitory computer-readable storage medium, configured to store instructions, wherein the method of claim 11 is implemented when the instructions are executed.
